(19) United States
(12) Patent Application Publication
(10) Pub. No.: US 2019/0166824 A1
(43) Pub. Date: Jun. 6, 2019

(54) TREE THRASHER BOX CALL

(71) Applicant: Tree Thrasher, LLC, Mount Pleasant, IA (US)

(72) Inventor: Todd Pringnitz, Mount Pleasant, IA (US)

(21) Appl. No.: 16/201,437

(22) Filed: Nov. 27, 2018

Related U.S. Application Data
(60) Provisional application No. 62/594,803, filed on Dec. 5, 2017.

(51) Int. Cl. A01M 31/00

(52) U.S. Cl. CPC A01M 31/004

(57) ABSTRACT

A game call includes an elongated cage portion having an open side and a plurality of sides wherein each of the plurality of sides includes at least one laterally positioned rib portion. A plate is movably coupled to the elongated cage portion on the open side wherein the plate includes at least one laterally positioned step. A first plurality of flaps is coupled to the at least one laterally positioned rib portion of the elongated cage portion. A second plurality of flaps is coupled to the at least one laterally positioned step of the plate. At least one cloth loop couples the elongated cage portion to the plate so the first plurality of flaps and the second plurality of flaps may pass over each other to simulate a rustling foliage sound.

### CROSS-REFERENCE TO RELATED APPLICATION

This application claims priority to and the benefit under 35 U.S.C. § 119(e) of U.S. Provisional Patent Application No. 62/594,803 filed on Dec. 5, 2017, entitled TREE THRASHER BOX CALL, the entire disclosure of which is hereby incorporated herein by reference.

### FIELD OF THE INVENTION

The present invention generally relates to a device and method for calling game and, more particularly, to a device that emulates a variety of sounds produced by many types of wildlife game.

### BACKGROUND OF THE INVENTION

Hunters typically employ a variety of different devices and methods for calling wild game into range to be shot by a rifle, bow, or other weapon. Typically, the sounds produced by these calls use a reed, or other type of vibration device, placed within a longitudinal passage. The hunter then forces air from the hunter's lungs through the passage to vibrate the reed or sound making device to produce a tone emulating a moose, elk, deer, water fowl, or wild turkey.

### BRIEF SUMMARY OF THE INVENTION

According to one aspect of the present invention, a game call includes an elongated cage portion having an open side and a plurality of sides wherein each of the plurality of sides includes at least one laterally positioned rib portion. A plate is movably coupled to the elongated cage portion on the open side wherein the plate includes at least one laterally positioned step. A first plurality of flaps is coupled to the at least one laterally positioned rib portion of the elongated cage portion. A second plurality of flaps is coupled to the at least one laterally positioned step of the plate. At least one cloth loop couples the elongated cage portion to the plate so the first plurality of flaps and the second plurality of flaps may pass over each other to simulate a rustling foliage sound.

According to another aspect of the present invention, a game call includes an elongated plastic cage having an open side and a plurality of sides wherein each of the plurality of sides includes at least one laterally positioned rib portion. A wooden plate is movably coupled to the elongated plastic cage on the open side wherein the wooden plate includes at least one laterally positioned step. A first plurality of plastic flaps is coupled to the at least one laterally positioned rib portion of the elongated plastic cage. A second plurality of plastic flaps is coupled to the at least one laterally positioned step of the wooden plate. At least one cloth loop couples the elongated plastic cage to the wooden plate so the first plurality of plastic flaps and the second plurality of plastic flaps may pass over each other to simulate a rustling foliage sound.

According to yet another aspect of the present invention, a method for calling game includes providing a game call. The game call includes an elongated cage portion having an open side and a plurality of sides wherein each of the plurality of sides includes at least one laterally positioned rib portion. Tree rubbing knobs are coupled to a corner edge of the elongated cage portion. A plate is movably coupled to the elongated cage portion on the open side wherein the wooden plate includes a laterally positioned step. A spring and a hammer are coupled to an outer face of the plate. A first plurality of flaps are coupled to the laterally positioned rib portion of the elongated cage portion. A second plurality of flaps is coupled to the laterally positioned step of the plate. One or more cloth loops couple the elongated cage portion to the plate. The game is called using one or more of the following techniques. The plate is moved along the elongated cage portion so the first plurality of flaps and the second plurality of flaps pass over each other to simulate a rustling foliage sound. A wood slapper is snapped down on the plate to simulate a branch breaking sound. The tree rubbing knobs rub against a tree to simulate an antler rubbing sound. The plate is struck with a hand to simulate a second branch breaking sound.

These and other features, advantages, and objects of the present invention will be further understood and appreciated by those skilled in the art by reference to the following specification, claims, and appended drawings.

### BRIEF DESCRIPTION OF THE DRAWINGS

The accompanying drawings are included to provide a further understanding, and are incorporated in and constitute a part of this specification. The drawings illustrate one or more embodiments, and together with the description serve to explain principles and operation of the various embodiments.

FIG. 1 is a side perspective view of the game call according to various aspects of the present disclosure;

FIG. 2 is a side view of the game call provided in FIG. 1;

FIG. 3 is an isolated perspective view of an elongated cage portion of the game call according to aspects of the present disclosure;

FIG. 4 is a top view of the game call of FIG. 1;

FIG. 5 is a side perspective view of the game call with a plate positioned in a starting position according to aspects of the present disclosure;

FIG. 6 is a back perspective view of the plate of the game call according to aspects of the present disclosure;

FIG. 7 is a front view of the plate and a spring and hammer according to aspects of the present disclosure;

FIG. 8 is a side view of the game call having a hanger according to aspects of the present disclosure;

FIG. 9 is a perspective view of a game call having a wood slapper according to aspects of the present disclosure;

FIG. 10 is a side perspective view of the game call having a wood slapper according to aspects of the present disclosure;

FIG. 11 is an exploded fragmentary view of an attachment portion for a hanger according to aspects of the present disclosure;

FIG. 12 is rear fragmentary view of a hanger according to aspects of the present disclosure; and

FIG. 13 is a flow diagram of a method for calling game according to aspects of the present disclosure.

### DETAILED DESCRIPTION

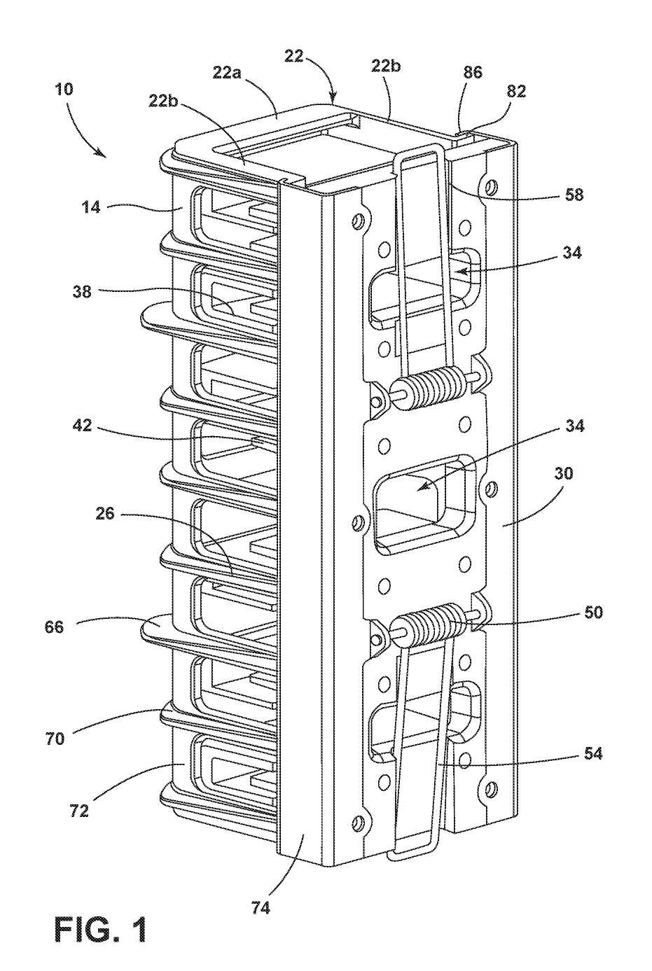

For purposes of description herein the terms “upper,” “lower,” “right,” “left,” “rear,” “front,” “vertical,” “horizontal,” and derivatives thereof shall relate to the device as oriented in FIG. 1. However, it is to be understood that the device may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

Referring to FIGS. 1-8, reference numeral 10 generally designates a game call. The game call 10 may include an elongated cage portion 14 having an open side 18 and a plurality of sides 22 wherein each of the plurality of sides 22 include at least one laterally positioned rib portions 26. The game call 10 additionally includes a plate 30 movably coupled to the elongated plastic cage 14 on the open side 18 wherein the plate 30 includes at least one laterally positioned step 34. A first plurality of flaps 38, typically plastic flaps, may be coupled to the one or more laterally positioned rib portions 26 of the elongated cage portion 14. A second plurality of flaps 42, typically plastic flaps, may be coupled to the one or more laterally positioned steps 34 of the plate 30. The game call 10 may also include at least one cloth loop 46 coupling the elongated cage portion 14 to the plate 30 so the first plurality of flaps 38 and the second plurality of flaps 42 may pass over each other to simulate a rustling foliage sound. Typically, the plurality of sides 22 can include three sides 22 that, along with the open side 18, forms a generally rectilinear prism shape. It is also contemplated that, the plurality of sides 22 can include two sides 22 that, along with the open side 18, forms a generally triangular prism shape. Other numbers of sides 22 can also be used to form the cage portion 14 of the game call 10.

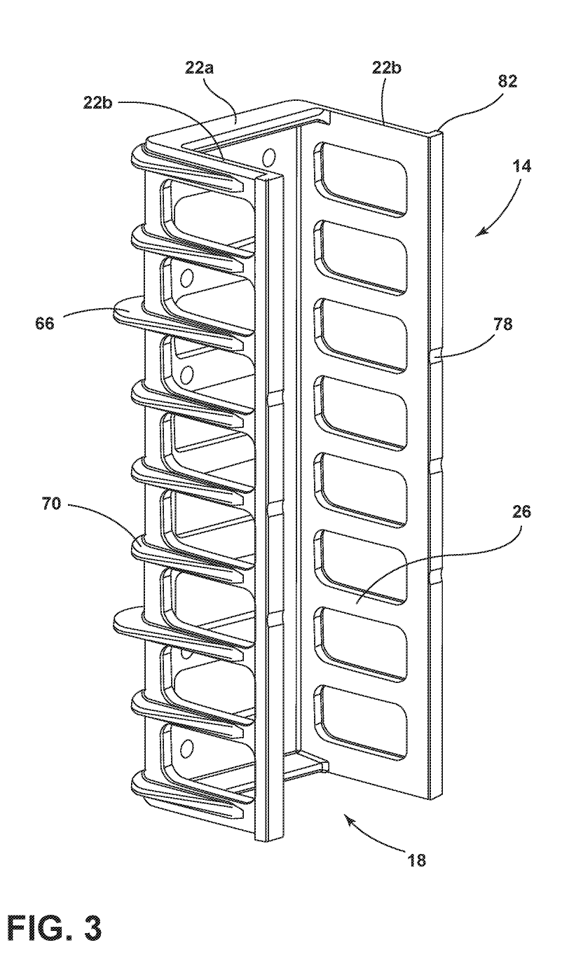

Referring to FIG. 1, a side perspective view of the game call 10 is provided. The game call 10 has the elongated cage portion 14 having three sides 22 including a back side 22a and two opposing sides 22b as best shown in FIG. 3. The elongated cage portion 14 additionally includes the one or more laterally positioned plurality of rib portions 26 where the first plurality of flaps 38 may be coupled therebetween. The game call 10 additionally has the plate 30 coupled to the elongated cage portion 14 where the plate 30 is coupled to a spring 50 and a hammer 54 coupled to an outer face plate 58. The plate 30 additionally has an inner face plate 62 that is in contact with the elongated cage portion 14 and coupled to the second plurality of flaps 42. The elongated cage portion 14 may additionally include one or more tree rubbing knobs 66 and one or more rib knobs 70 coupled to a corner edge 72 of the elongated cage portion 14. A plate side member 74 couples the plate 30 to the elongated cage portion 14.

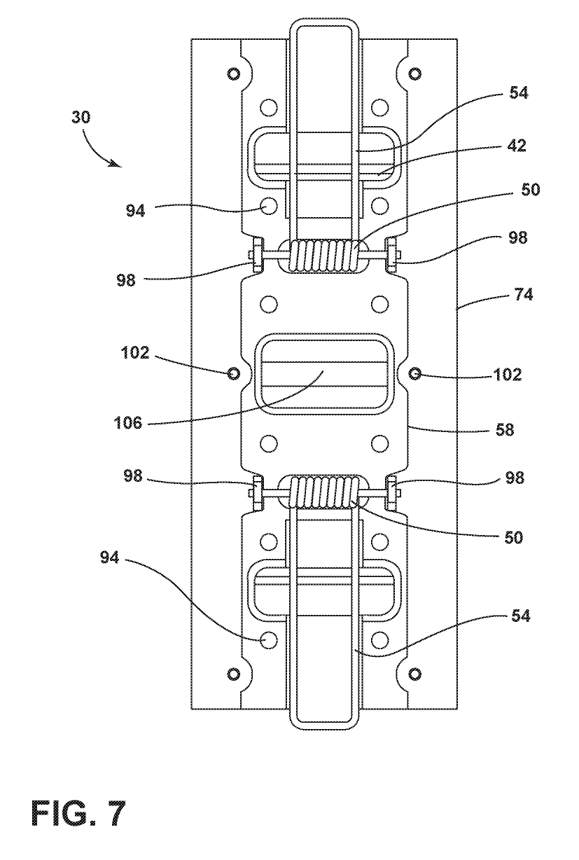

In some aspects, the elongated cage portion 14 may be made a variety of different materials, for example, wood, metal, plastic, thermoplastic resin, thermoset resin, rubber, ceramic, glass, rock, or a combination thereof. In some aspects, the elongated cage portion 14 may be made from a plastic material. The one or more laterally positioned rib portions 26 may run parallel to each other perpendicular to the longitudinal axis of the elongated cage portion 14 and may have a variety of different widths or thicknesses. In some aspects, the number of laterally positioned plurality of rib portions 26 may include from two up to 20 rib portions 26 (including all integers in the range). In some aspects, the number of laterally positioned rib portions 26 and their related design may be manipulated for maximum noise distribution from the various sound generating mechanisms produced from the game call 10. One or more support members 106 (shown in FIG. 7) may be coupled to the elongated cage portion 14 along the rib portions 26 on the back side 22a. The one or more support members 106 may be made from a variety of materials including, for example, wood, plastic, thermoplastic resin, thermoset resin, rubber, or a combination thereof. In some aspects, the one or more support members 106 provide a cage surface for the first plurality of flaps 38 to be coupled. In other aspects, the first plurality of flaps 38 are coupled directly to the plurality of laterally positioned rib portions 26.

The first and second plurality of flaps 38, 42 may be made from a variety of different materials including, for example, polyethylene, polypropylene, polyester, polyether, polymer blends, thermoplastics, thermosets, other plastic material, or a combination thereof used to make a thrashing and/or rustling foliage or rustling leaves sound. Both the positioning and the material used for the first and second plurality of flaps 38, 42 may be varied by the user to customize the sound made by the game call 10.

The spring 50 and hammer 54 coupled to the outer face 58 of the plate 30 may be varied or adjusted to tune the simulated sound of the breaking branches. In some aspects, the strength and/or position of the spring 50 may be adjusted to control the strength and sound of the snap. In other aspects, the size and corresponding thickness of the hammer 54 may be adjusted to control the strength and sound of the snap. Depending on the design and desired applications of the game call 10, the number of spring 50 and hammer 54 calls may be varied and may be, for example, two, three, four, or more. Additionally, when two or more spring 50 and hammer 54 setups are applied to the game call 10, each of the setups may be independently varied by adjusting the spring 50 and/or hammer 54, as explained above, to vary the options of snapping branch sounds. In some aspects, the game call 10 may be adjusted or fitted with two or more different spring 50 and hammer 54 combinations where each spring 50 and hammer 54 combination has an adjustable and different branch snapping sound.

Depending on the design and desired applications of the game call 10, the number of laterally positioned steps 34 formed into the plate 30 may include from two up to 20 steps 34 (including all integers not listed in the provided number of steps). One or more support members 106 (shown in FIG. 7) may be coupled along the inner face 62 of the plate 30. Like the support members 106 coupled to the elongated cage portion 14 and/or rib portions 26, the one or more support members 106 may be made from a variety of materials including, for example, wood, plastic, thermoplastic resin, thermoset resin, rubber, or a combination thereof. In some aspects, the one or more support members 106 provide a plate surface for the second plurality of flaps 42 to be coupled. In other aspects, the second plurality of flaps 42 are coupled directly to the plurality of laterally positioned steps 34.

In some aspects, the plate 30 may be made a variety of different materials, for example, wood, metal, plastic, thermoplastic resin, thermoset resin, rubber, ceramic, glass, rock, or a combination thereof. In some aspects, the plate 30 may be made, fabricated, cast, or formed from a wood or wooden material. In aspects where the plate 30 is made of wood, the thickness, dimensions, and type of wood may be varied to adjust the sound of the snapping branch sound when the spring 50 and hammer 54 mechanism is used in combination with it.

The tree rubbing knobs 66 and/or rib knobs 70 may be designed to simulate an antler rubbing sound when the tree rubbing knobs 66 and/or rib knobs 70 are rubbed against a tree, log, or other surface found in a hunting environment. Both the tree rubbing knobs 66 and/or rib knobs 70 can be made from the same material or materials as the elongated cage portion 14. In some aspects, each of the rib portions 26 may have either two tree rubbing knobs 66 or rib knobs 70. The main difference between the tree rubbing knobs 66 and the rib knobs 70 are the size of the bump positioned on the corner edges 72 of the elongated cage portion 14.

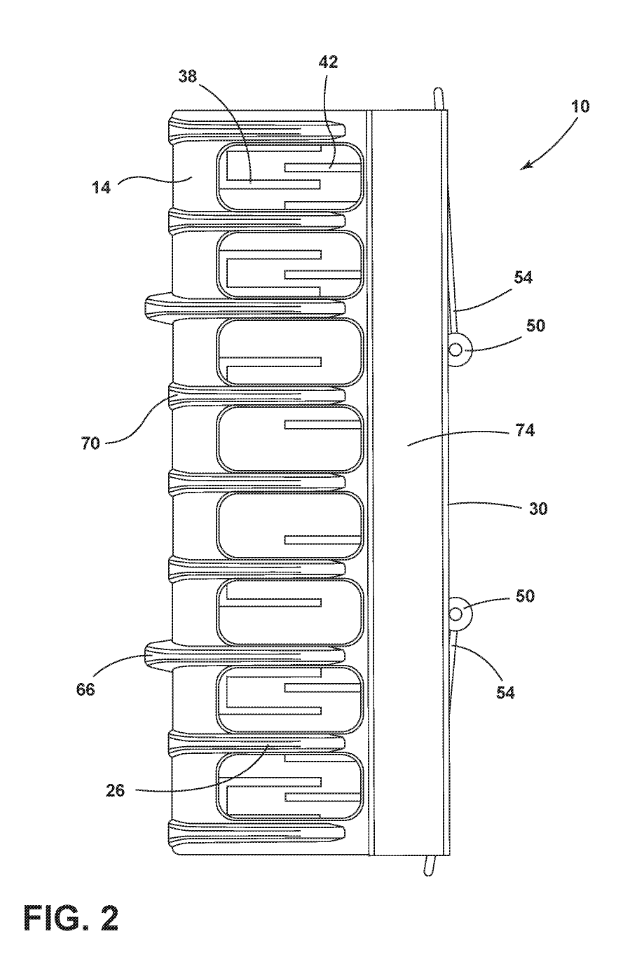

Referring now to FIG. 2, a side view of the game call 10 is provided. The elongated cage portion 14 is presented to show one of the opposing sides 22b (FIG. 3) and a plurality of the rib portions 26 having the rib knobs 70 and tree rubbing knobs 66 shown. The first and second plurality of flaps 38, 42 are shown respectively coupled to the elongated cage portion 14 and the plate 30. The plate side member 74 is shown partially overlapping the elongated cage portion 14 to couple this portion. The plate 30 is shown coupled to one or more springs 50 that couple the one or more hammers 54.

The game call 10 may be used to provide several different calls or sounds that represent various noises that animals may produce in the wild. For example, the game call 10 may simulate a leaf-like noise, a thrashing sound, a rustling foliage sound, a branch breaking sound, an antler rubbing sound, a foot stomping sound, a shaking tree sound, a shaking bush sound, or combinations thereof. In some aspects of the device, the game call 10 may not make any grunting, bleating, or other additional vocal sounds made by the vocal system of the wild game or animal itself. In such an embodiment, the game call 10 may be used to call in, attract, distract, lure, or bait in a variety of large and small game including, for example, moose, elk, deer, mule deer, water fowl, wild turkey, or any combination thereof using non-vocal animal sounds. The formation of the various vocal calls and non-vocal sounds that can be made using the game call 10 will be described more fully below.

Referring now to FIG. 3, the elongated cage portion 14 is shown with an elongated cage flange 82 and one or more finger portions 78 that couple the plate 30 (FIG. 1). The open side 18 provides a space where the plate 30 may be attached and/or coupled to the elongated cage portion 14.

The one or more finger portions 78 can be made from the same material or materials as the elongated cage portion 14. The size and spacing of the one or more finger portions 78 can be varied to couple with the plate 30 to provide a variety of grinding noises that can be combined with the thrashing/rustling foliage sounds produced.

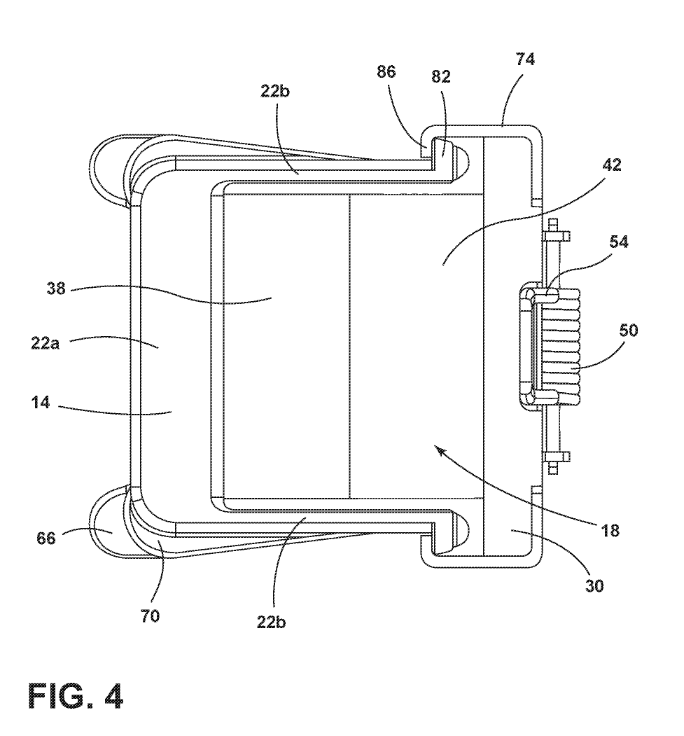

Referring now to FIG. 4, a top view of the game call 10 is shown where the plate 30 is coupled to the elongated cage portion 14 using the elongated cage flange 82 coupled to the plate flange 86 of the plate side member 74. Both the elongated cage flange 82 and the plate flange 86 portions overlap to form a slidably coupled interface between the elongated cage portion 14 and the plate 30. The top view of the elongated cage portion 14 clearly shows the back side 22a and opposing sides 22b forming three sides of the game call 10. The plate 30 is coupled on the open side 18 where both the elongated cage portion 14 and plate 30 contain all of the previously mentioned features, for example, the spring 50 and hammer 54.

In some aspects, the plate side member 74 may include a separate piece or portion coupled directly to the plate 30, but in other aspects, the plate side member 74 may be a portion of the plate 30 wherein both the plate side member 74 and the plate 30 make up a single piece. In some aspects, the plate 30 and plate side member 74 may be formed, cast, manufactured, or carved from a single piece of material, for example, wood. The wood used to make the plate 30 and/or plate side member 74 may be, for example, white pine, pine, cedar, oak, poplar, maple, mahogany, cherry, or a combination thereof. The type of material(s) used to make the plate 30 can influence the sounds produced by the game call 10. Various plates 30 made of various materials may be interchangeable on the game call 10.

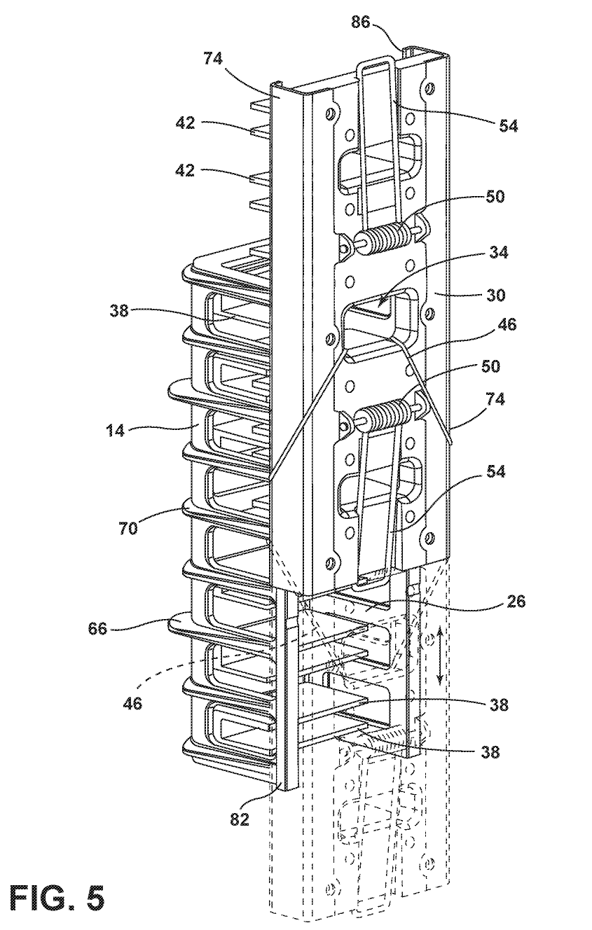

Referring now to FIG. 5, the game call 10 is shown where the plate 30 is slid along the elongated cage portion 14 so that the first and second plurality of flaps 38, 42 may flip and rub against each other to simulate the rustling foliage sound. A user may slide the plate 30 and elongated cage portion 14 back and forth at a desired rate to simulate the desired rustling foliage sound. One or more cloth loops 46 may be used help couple both the elongated cage portion 14 and the plate 30 by looping the cloth loop 46 around and through the one or more laterally positioned rib portions 26 and one or more of the laterally positioned steps 34. In some aspects, the one or more fastened or coupled cloth loops 46 are long enough so that the plate 30 has room to slide relative to the elongated cage portion 14 so that the first and second plurality of flaps 38, 42 may pass over each other to simulate the rustling foliage sound. The cloth loops 46 may also include a cloth cover that can be manipulated to produce sound with the noise-producing plastic interior of the cage portion 14.

The cloth loops 46 may create the thrashing and/or rustling foliage sound or a more general leaf noise when cycled during the back and forth motion of the plate 30 relative to the elongated cage portion 14. The cloth loops 46 controls the travel of the game call 10 when cycled back and forth and keeps the plate portion 30 coupled to the elongated cage portion 14. In some aspects, the cloth loops 46 may have a cloth surface (e.g. cotton, polyester, nylon, silk, denim, chambray, flannel) and a plastic interior (e.g. polyethylene, polypropylene, polyester, polyether, thermoplastics, thermosets) to form a combined material that crinkles and makes a thrashing and/or rustling foliage or rustling leaves sound.

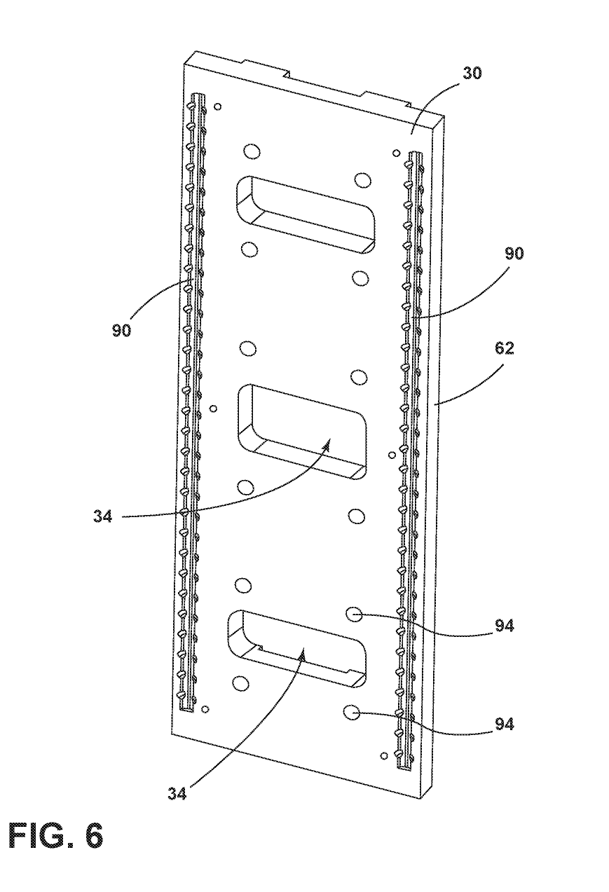

Referring now to FIG. 6, a rear view of the plate 30 is shown where the plate 30 includes at least one elongated groove 90, and typically at least two grooves 90, that may couple with the finger portions 78 of the elongated cage portion 14. The one or more steps 34 are formed in the plate 30 in addition to one or more receiving members 94. The one or more receiving members 94 may be coupled to one or more support members 106 where the support members 106 may be coupled to the second plurality of flaps 42, the one or more cloth loops 46, and a plurality of scrubber portions (not shown).

Referring now to FIG. 7, a front view of the plate 30 is shown where the spring 50 is coupled to one or more spring mounts 98 so that the hammer 54 may be pressed and/or snapped against the outer face 58 of the plate 30. In addition to the plurality of receiving members 94, one or more second receiving members 102 may be present to provide additional coupling points for the one or more support members 106.

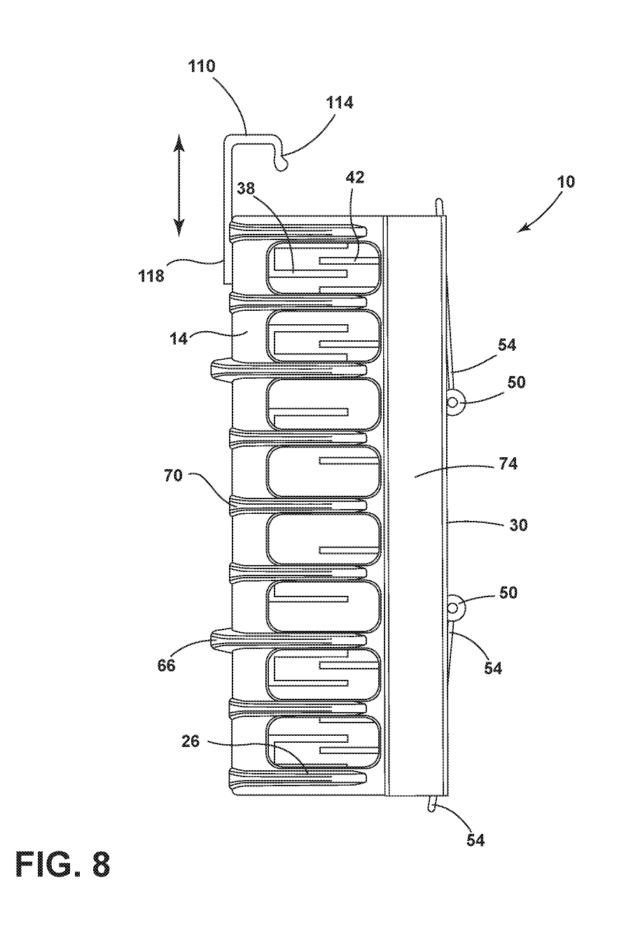

Referring now to FIG. 8, a side view showing another aspect of the game call 10 is provided. The elongated cage portion 14 is presented to show one of the opposing sides 22b (FIG. 3) including a plurality of the rib portions 26 having rib knobs 70 and tree rubbing knobs 66. The first and second plurality of flaps 38, 42 are shown respectively coupled to the elongated cage portion 14 and the plate 30. The plate side member 74 is shown partially overlapping the elongated cage portion 14 to couple the plate 30. The plate 30 is shown coupled to one or more springs 50 that couple the one or more hammers 54. Additionally provided in this aspect is a hanger 110 having a hook 114 and an attachment portion 118. The attachment portion 118 couples the hook 114 to the elongated cage portion 14. This attachment portion 118 may have a means for sliding back and forth to extend and retract the hanger 110 so the user can attach the game call 10 to a variety of different objects (e.g. tree stand, ground blind, branch, tree, mount) while still being able to access and manipulate the game call 10. In some aspects, the attachment portion 118 may be, for example, a rail system, a channel system, a crank system, a cam system, a ball bearing system, or a combination thereof. In other aspects, the attachment portion 118 may slide in and out of the elongated cage portion 14 to conceal the hanger 110 when the attachment portion 118 is in a retracted state.

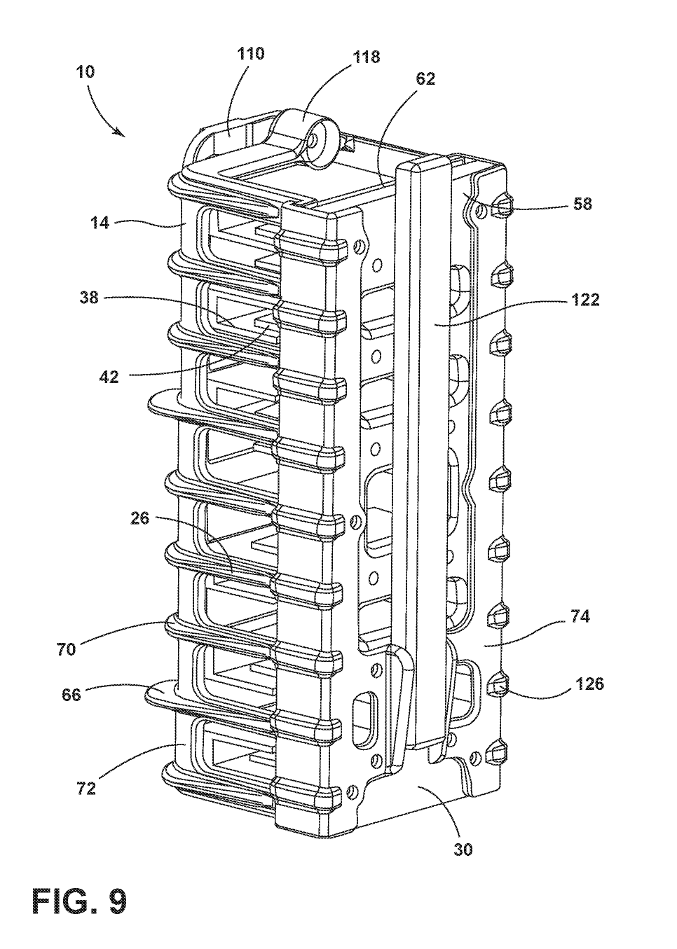

Referring to FIG. 9, a side perspective view of the game call 10 is provided. The game call 10 has the elongated cage portion 14 with the one or more laterally positioned rib portions 26 and the first plurality of flaps 38 may be coupled therebetween. The game call 10 additionally has the plate 30 coupled to the elongated cage portion 14 where the plate 30 is coupled to a wood slapper 122 coupled to the outer face plate 58. The plate 30 additionally has the inner face plate 62 that is in contact with the elongated cage portion 14 and coupled to the second plurality of flaps 42. The elongated cage portion 14 may additionally include at least one, and typically a plurality of, tree rubbing knobs 66 and at least one or a plurality of rib knobs 70 coupled to a corner edge 72 of the elongated cage portion 14. The plate side member 74 couples the plate 30 and one or more plate knobs 126 to the elongated cage portion 14.

The wood slapper 122 may be used in some aspects as an alternative or in combination with the spring 50 and hammer 54. The wood slapper 122 may be coupled to the outer face 58 of the plate 30 using the spring 50 or other tensioned part that can be adjusted to simulate the sound of breaking branches. The plate 30 may be additionally made from wood or other composite. In other aspects, the size and corresponding thickness of the wood slapper 122 may be adjusted to control the strength and sound of the snap. Depending on the design and desired applications of the game call 10, the number of wood slapper 122 calls may be varied and may be, for example, one, two, three, four, or more. Additionally, the connection, dimensions, and/or type of wood used for the wood slapper 122 may be varied to alter or vary the snapping branch sounds produced by the game call 10.

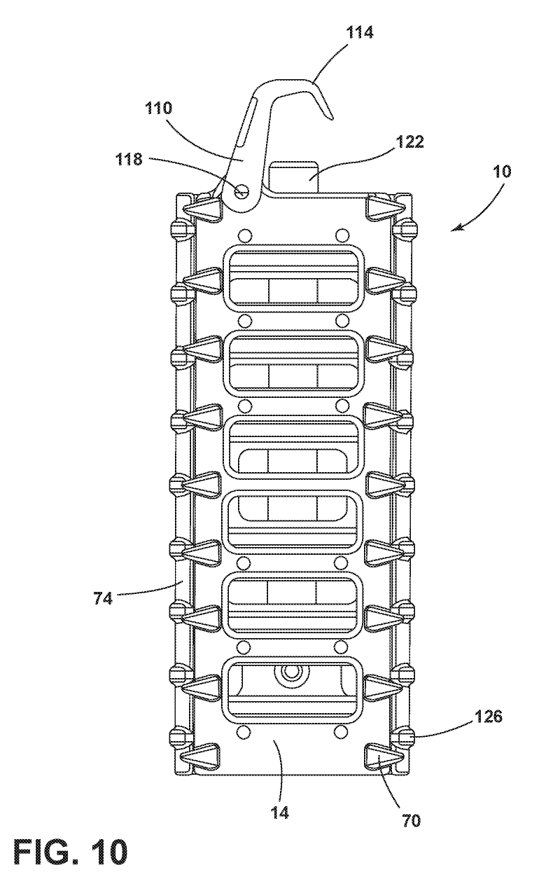

Referring to FIG. 10, a rear view of the game call 10 is provided with the hook 114 of the hanger 110 extended from the attachment portion 118 according to some aspects of the present disclosure. The wood slapper 122 is coupled to the outer face plate 58 so it makes contact with the plate 30 in a retracted or stored energy position. A plurality of plate knobs 126 may be positioned along the outside edge of the plate side member 74 to provide a surface that can be rubbed against a surface such as a tree or log to simulate an antler rubbing sound. The rib knobs 70 coupled to the edge corner of the elongated cage 14 can be used as described above.

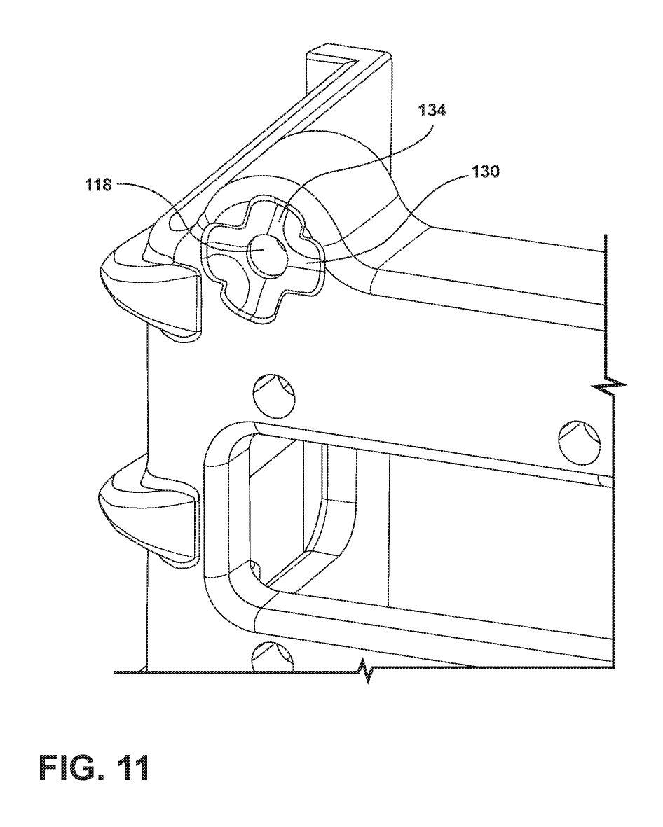

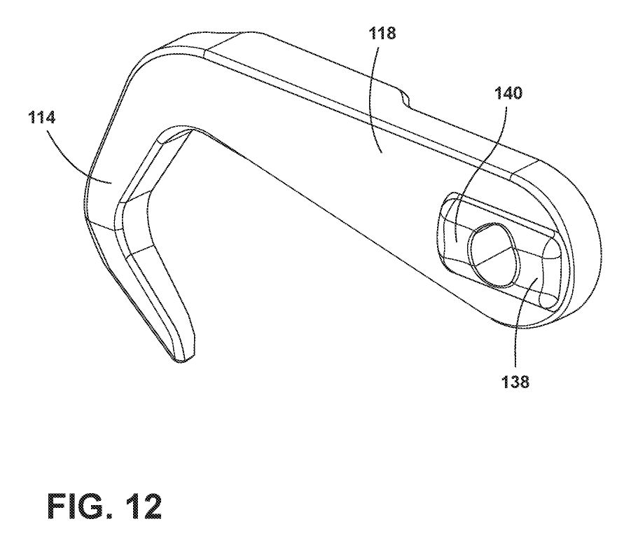

Referring to FIGS. 11 and 12, the attachment portion 118 may have a first notch 130 and a second notch 134 used to position a flange 138 coupled to the hanger 110 and/or hook 114. The flange 138 may have a raised portion 140 formed in a geometrical shape, for example, a cone, a rectangle, or a square. The shape of the raised portion 140 of the flange 138 may hook and/or nest in the first notch 130 or second notch 134 to position the hanger 110 in a lowered/retracted position (flange 138 positioned in the first notch 130) or an extended/risen position (flange 138 positioned in the second notch 134).

The descriptions outlining and teaching the game call 10 shown and described in FIGS. 1 and 9 would teach a person skilled in the art how to design and/or produce a game call 10 having the ability to produce one or more different sounds that could be used to call or signal wildlife such as, for example, moose, elk, deer, water fowl, or wild turkey. The aspects and embodiments previously described in the figures and description here, which can be used in any combination, apply equally well to any combination of signals for calling game. In some aspects, the game call 10 is as provided in FIG. 9. In some aspects, the game call 10 is as provided in FIG. 1. In some aspects, the game call 10 is as provided using a mix of features of the game calls 10 provided in FIGS. 1 and 9.

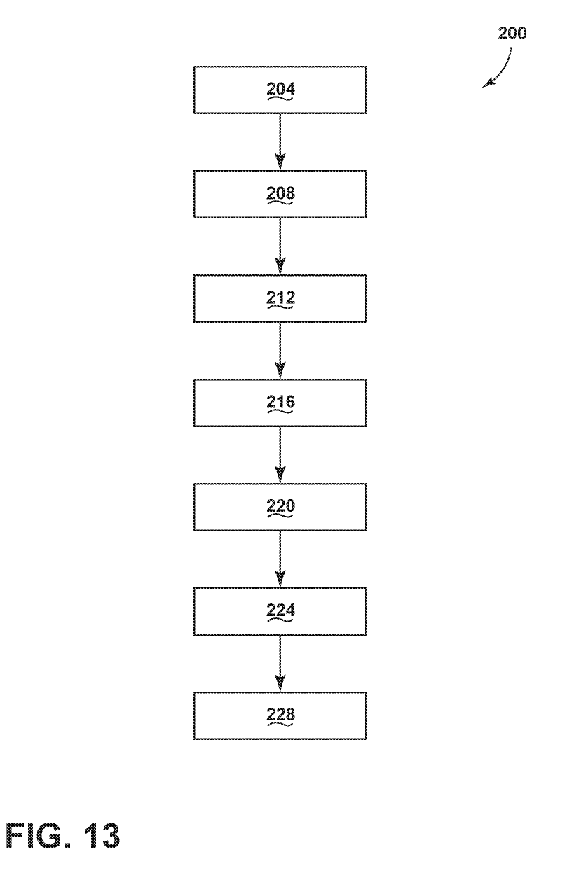

Referring now to FIG. 13, a method 200 for calling game is provided using the game call 10 provided in FIGS. 1-12 as previously shown and described. The method 200 may begin with a step 204 that includes providing the game call 10 having the elongated cage portion 14 having the open side 18 and three sides 22 wherein each of the three sides 22 include one or more laterally positioned rib portions 26. The game call 10 additionally includes one or more tree rubbing knobs 66 that may be coupled to a corner edge 72 of the elongated cage portion 14. The plate 30 may be movably coupled to the elongated cage portion 14 on the open side 18 wherein the plate 30 includes one or more laterally positioned steps 34. The plate 30 may include the spring 50 and the hammer 54 coupled to the outer face 58 of the plate 30. The first plurality of flaps 38 may be coupled to the one or more laterally positioned rib portions 26 of the elongated cage portion 14 and the second plurality of flaps 42 may be coupled to the one or more laterally positioned steps 34 of the plate 30. One or more cloth loops 46 are used to help couple the elongated cage portion 14 to the plate 30.

Next, step 208 includes simulating a call or noise made by an animal in the wild. Step 208 may accomplished by using any one or more of the following techniques or additional steps. It should be understood that the various noise-making steps of the method 200 may be performed individually and without the addition of the remaining noise-making steps. Additionally, the various noise-making steps described herein with respect to method 200 can be performed in any sequence or permutation of sequences.

Step 212 includes moving the plate 30 back and/or forth along the elongated cage portion 14 so the first plurality of flaps 38 and the second plurality of flaps 42 may pass over each other to simulate the thrashing and/or rustling foliage sound. The plate 30 may be pushed at a variety of different pressures to change the underlying grinding sounds provided by the one or more finger portions 78. In addition, the speed of the moving the plate 30 back and/or forth relative to the elongated cage portion 14 can change the intensity and volume of the thrashing and/or rustling foliage sound as desired by the user. In some aspects, the stroke length of the back and/or forth motion can change the intensity and volume of the thrashing and/or rustling foliage sound as desired by the user.

Step 216 includes snapping the hammer 54 or wood slapper 122 down on the plate 30 to simulate a branch breaking sound. As previously discussed, more than one wood slapper 122 and/or spring 50 and hammer 54 combination may be mounted to the plate 30 to provide different intensity and/or volume of branches breaking. The user may alternate making the branch breaking sound(s) between the two or more wood slapper 122 and/or spring 50 and hammer 54 setups available on the game call 10 or may predominately use just one of the wood slapper 122 or spring 50 and hammer 54 setups.

Step 220 includes rubbing the one or more tree rubbing knobs 66 and/or one or more rib knobs 70 against a tree, branch, log, or other wooded surface to simulate the antler-rubbing sound. The positioning/spacing of the tree rubbing knobs 66 and/or rib knobs 70 and the force with which they are pushed against the wooden surface by the user will vary the antler rubbing sound produced. In some aspects, the game call 10 may have exclusively tree rubbing knobs 66 or rib knobs 70, and in other aspects, the game call 10 may have both tree rubbing knobs 66 and rib knobs 70. As described above, the difference between the tree rubbing knobs 66 and the rib knobs 70 are their respective size with the tree rubbing knobs 66 being larger than the rib knobs 70. In some aspects, a plurality of different sizes may be used for the tree rubbing knobs 66 to complement the rib knobs 70.

Step 224 includes striking the plate 30 with a hand of the user to simulate a second branch breaking sound. Striking the plate 30 may be initiated by the user by hitting the plate 30 anywhere on its outer face 58. The force and positioning of the hit can vary the sound of the simulated branch breaking. The second simulated branch breaking sound produced from striking the plate 30 with the hand may sound different from the simulated branch breaking sounds produced from the spring 50 and hammer 54 setups described above. In some aspects, the second branch breaking sound may have a lower volume and may be a more subtle sound than the simulated branch breaking sounds produced from the spring 50 and hammer 54.

Step 228 includes an additional step of removing the first and second plurality of flaps 38, 42 and/or plurality of scrubber portions and replacing them with a replacement or substitute second set of first and second plurality of flaps 38, 42 and/or a replacement or substitute plurality of scrubber portions that include different materials to alter the simulated thrashing and/or rustling foliage sounds. In some aspects, the game call 10 may be adjusted by replacing some of its components or parts to adjust or change the sounds the game call 10 produced. For example, the first and second plurality of flaps 38, 42, the plurality of scrubber portions, the spring 50 and hammer 54 setups, the plate 30, the one or more cloth loops 46, or any combination thereof may be changed or slightly modified to change the simulated sounds produced. In some aspects, the first and second plurality of flaps 38, 42 and/or plurality of scrubber portions may be repositioned or have their respective materials changed to customize the sounds made by the game call 10.

Referring again to step 208, any one or combination of calls may be used on the game call 10. In some aspects, the game call 10 may be considered a variable game call or a multi-call game call. For example, in some aspects the simulated sound may exclusively be the thrashing or rustling foliage sound, may exclusively be the branch breaking sound, may exclusively be the antler rubbing sound, or may exclusively be a hoof or foot stomping sound. In alternative aspects, the simulated sound(s) may be any simultaneous or sequential combination of 2, 3, and/or 4 options that may be incorporated on the game call 10. For example, the thrashing or rustling foliage sound may be combined simultaneously or sequentially with the branch breaking sound as desired by the user.

It is understood that the descriptions outlining and teaching the game call 10 previously discussed, which can be used in any combination, apply equally well to the method 200 for calling game.

It will be understood by one having ordinary skill in the art that construction of the described device and other components may not be limited to any specific material. Other exemplary embodiments of the device disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the device as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present device. The exemplary structures and processes disclosed herein are for illustrative purposes and are not to be construed as limiting.

It is also to be understood that variations and modifications can be made on the aforementioned structure without departing from the concepts of the present invention, and further it is to be understood that such concepts are intended to be covered by the following claims unless these claims by their language expressly state otherwise.

The above description is considered that of the illustrated embodiments only. Modifications of the device will occur to those skilled in the art and to those who make or use the device. Therefore, it is understood that the embodiments shown in the drawings and described above is merely for illustrative purposes and not intended to limit the scope of the device, which is defined by the following claims as interpreted according to the principles of patent law, including the Doctrine of Equivalents.

The invention claimed is:

1. A game call comprising:
an elongated cage portion having an open side and a plurality of sides wherein each of the plurality of sides includes at least one laterally positioned rib portion;
a plate movably coupled to the elongated cage portion on the open side wherein the plate includes at least one laterally positioned step;
a first plurality of flaps coupled to the at least one laterally positioned rib portion of the elongated cage portion;
a second plurality of flaps coupled to the at least one laterally positioned step of the plate; and
at least one cloth loop coupling the elongated cage portion to the plate so the first plurality of flaps and the second plurality of flaps may pass over each other to simulate a rustling foliage sound.

2. The game call of claim 1, wherein the first and second plurality of flaps comprise plastic flaps.

3. The game call of claim 1, further comprising:
a wood slapper coupled to an outer face of the plate wherein operation of the wood slapper is configured to snap down on the plate to simulate a branch breaking sound.

4. The game call of claim 1, further comprising:
a spring and a hammer coupled to an outer face of the plate wherein the hammer is configured to snap down on the plate to simulate a branch breaking sound.

5. The game call of claim 1, wherein the at least one cloth loop comprises a cloth cover and a noise-producing plastic interior.

6. The game call of claim 1, further comprising:
a plurality of tree rubbing knobs coupled to a corner edge of the elongated cage portion, wherein the plurality of tree rubbing knobs is configured to be scraped against a tree to simulate an antler-rubbing sound.

7. The game call of claim 1, wherein the plate comprises a wooden material, and wherein the elongated cage portion comprises a plastic material.

8. The game call of claim 1, wherein the plate comprises at least two grooves positioned on edges of an inner face that extend a length of the plate wherein the grooves couple a flange of the elongated cage portion.

9. The game call of claim 1, further comprising:
a plurality of scrubber portions coupled to the at least one laterally positioned rib portion of the elongated cage portion.

10. A game call comprising:
an elongated plastic cage having an open side and a plurality of sides wherein each of the plurality of sides includes at least one laterally positioned rib portion;
a wooden plate movably coupled to the elongated plastic cage on the open side wherein the wooden plate includes at least one laterally positioned step;
a first plurality of plastic flaps coupled to the at least one laterally positioned rib portion of the elongated plastic cage;
a second plurality of plastic flaps coupled to the at least one laterally positioned step of the wooden plate; and
at least one cloth loop coupling the elongated plastic cage to the wooden plate so the first plurality of plastic flaps and the second plurality of plastic flaps may pass over each other to simulate a rustling foliage sound.

11. The game call of claim 10, further comprising:
a spring and a hammer coupled to an outer face of the plate wherein the hammer may snap down on the wooden plate to simulate a branch breaking sound.

12. The game call of claim 10, further comprising:
a wood slapper coupled to an outer face of the plate wherein the wood slapper may snap down on the wooden plate to simulate a branch breaking sound.

13. The game call of claim 10, wherein the at least one cloth loop comprises a cloth cover and a noise-producing plastic interior.

14. The game call of claim 10 further comprising:
at least one tree rubbing knob coupled to a corner edge of the elongated plastic cage wherein the at least one tree rubbing knob is configured to be scraped against a tree to simulate an antler rubbing sound.

15. The game call of claim 10, wherein the plate comprises at least two grooves positioned on edges of an inner face that extend a length of the plate wherein the grooves couple a flange of the elongated plastic cage.

16. The game call of claim 10 further comprising:
a plurality of scrubber portions coupled to the at least one laterally positioned step of the plate.

17. A method for calling game, the method comprising:
providing a game call comprising:
an elongated cage portion having an open side and a plurality of sides wherein each of the plurality of sides includes at least one laterally positioned rib portion;
tree rubbing knobs coupled to a corner edge of the elongated cage portion;
a plate movably coupled to the elongated cage portion on the open side wherein the wooden plate includes a laterally positioned step;
a spring and a hammer coupled to an outer face of the plate;
a first plurality of flaps coupled to the laterally positioned rib portion of the elongated cage portion;
a second plurality of flaps coupled to the laterally positioned step of the plate; and
one or more cloth loops coupling the elongated cage portion to the plate;
calling the game using one or more of the following techniques:
moving the plate along the elongated cage portion so the first plurality of flaps and the second plurality of flaps pass over each other to simulate a rustling foliage sound;
snapping a wood slapper down on the plate to simulate a branch breaking sound;
rubbing the tree rubbing knobs against a tree to simulate an antler rubbing sound; and
striking the plate with a hand to simulate a second branch breaking sound.

18. The method for calling game of claim 17, wherein the plate comprises grooves positioned on edges of an inner face that extend a length of the plate wherein the grooves couple a flange of the elongated cage portion to the plate.

19. The method for calling game of claim 17, further comprising:
replacing at least one of the first plurality of flaps and the second plurality of flaps with a substitute plurality of flaps to simulate a different rustling foliage sound.

20. The method for calling game of claim 17, further comprising:
replacing a plurality of scrubber portions with a substitute plurality of scrubber portions to simulate a different rustling foliage sound, wherein the plurality of scrubber portions is coupled to at least one of the laterally positioned rib portions of the elongated cage portion and the laterally positioned step of the plate to further simulate rustling foliage sounds.
